(19) United States
(12) Patent Application Publication
(10) Pub. No.: US 2026/0134521 A1
(43) Pub. Date: May 14, 2026

(54) Removing Distortion from Real-Time Video Using a Masked Frame

(71) Applicant: Google LLC, Mountain View, CA (US)

(72) Inventors: Hsueh-Ping Chen, New Taipei City (TW); Fuhao Shi, San Jose, CA (US); Sung-Fang Tsai, Mountain View, CA (US); Po-Hao Huang, Taipei (TW); Po-Ya Hsu, Zhubei City (TW)

(21) Appl. No.: 19/115,643

(22) PCT Filed: Sep. 26, 2023
(86) PCT No.: PCT/US2023/033762

§ 371 Date: Mar. 26, 2025

Related U.S. Application Data
(60) Provisional application No. 63/377,484, filed on Sep. 28, 2022.

(51) Int. Cl. G06T 5/73; G06T 5/60; G06T 7/194; G06T 7/215

(52) U.S. Cl. CPC G06T 5/73; G06T 5/60; G06T 7/194; G06T 7/215; G06T 2207/10016; G06T 2207/20081; G06T 2207/20192; G06T 2207/20201

(57) ABSTRACT

This document describes systems and techniques for removing distortion from real-time video using a masked frame. In aspects, an image-capture device having a video-processing manager is configured to capture a video segment comprising a sequence of frames. The sequence of frames includes at least a current frame having a foreground and a background. The video-processing manager receives a subject mask, motion vectors, and a predicted mask for the current frame. The video-processing manager generates a final mask for the current frame based on the subject mask, motion vectors, and predicted mask. The video-processing manager applies the final mask to the current frame to segment the foreground from the background and provide a masked frame. The video-processing manager edits the masked frame to remove distortion to generate an output frame and outputs the output frame. By repeating the method described for each frame in the sequence of frames, the video-processing manager provides an improved video segment.

### CROSS-REFERENCE TO RELATED DISCLOSURE

This application claims priority to U.S. Provisional Application No. 63/377,484, filed Sep. 28, 2022, which is incorporated herein by reference in its entirety.

### BACKGROUND

Many video applications apply modifications to a video segment in a global way. That is, for a video segment that includes a foreground and a background, modifications are applied equally to both the foreground and the background. For example, motion blur can be applied globally to a video segment to hide judder artifacts resulting from a three-two pulldown or a quickly panned action shot. However, for video segments that include salient foregrounds, global application of motion blur results in blurry salient foregrounds, which may be undesirable.

### SUMMARY

This document describes systems and techniques for removing distortion from real-time video using a masked frame. In aspects, an image-capture device having a video-processing manager is configured to receive a video segment comprising a sequence of frames. The sequence of frames includes at least a current frame having a foreground and a background. The video-processing manager receives a subject mask, motion vectors, and a predicted mask for the current frame. The video-processing manager generates a final mask for the current frame based on the subject mask, motion vectors, and predicted mask. The video-processing manager then applies the final mask to the current frame to segment the foreground from the background and provide a masked frame. The video-processing manager edits the masked frame to remove distortion to generate an output frame and outputs the output frame. By repeating the method described for each frame in the sequence of frames, the video-processing manager provides an improved video segment with less distortion.

Details of one or more aspects of removing distortion from real-time video using a masked frame are set forth in the accompanying drawings and the following description. Other features and advantages will be apparent from the drawings, the description, and the claims. This summary is provided to introduce subject matter that is further described in the Detailed Description and Drawings. Accordingly, this summary does not describe essential features, nor does it limit the scope of the claimed subject matter.

### BRIEF DESCRIPTION OF THE DRAWINGS

This specification describes systems and techniques for removing distortion from real-time video using a masked frame with reference to the following drawings, in which the same numbers are used throughout the drawings to reference similar features and components:

FIG. 1 illustrates an example environment in which an image-capture device may implement aspects of removing distortion from real-time video using a masked frame;

FIG. 2 illustrates an example implementation of the image-capture device from FIG. 1 in more detail;

FIG. 3 illustrates an example method for extracting a foreground from a video segment in accordance with one or more aspects; and

FIG. 4 illustrates an example method for segmenting a current frame of a sequence of frames to produce a segmentation result.

### DETAILED DESCRIPTION

### Overview

Since the advent of video cameras, engineers have strived to improve their capabilities so that the videos they capture appear life-like. To do so, engineers have focused on improving resolution and framerate capabilities. Unlike displays, reality is not limited to a finite resolution comprised of a finite number of individual pixels, or light sources. Rather, reality can be thought of as having an infinite resolution. Accordingly, a camera that is capable of capturing videos of a scene in a high resolution is important for a life-like representation of the scene. Also, unlike displays, reality is not limited to a finite framerate comprised of a finite number of frames, or still images, displayed rapidly in succession. Rather, reality can be thought of as having an infinite framerate. Accordingly, a camera that is capable of capturing videos of a scene at a framerate that is very high is important for a life-like representation of the scene. Given unlimited resources, space, and time, engineering a camera with such capabilities is trivial. However, without unlimited resources, space, and time, engineers have developed alternative solutions.

As an example, a parent attends their child's track meet, where the child is scheduled to participate in a 100-meter (100-m) dash. They line up at the starting line, shaking out their legs in preparation. Before the starting gun is fired, the parent opens a camera application on a smartphone and selects a video mode set to capture a 1080p recording at 30 frames per second (fps). When the starting gun is fired, the child takes off like a rocket down the track. Meanwhile, the parent begins capturing a video segment using the smartphone. The parent quickly pans the camera to keep their child in focus and centered in the frame as they zoom past the parent toward the finish line. As they approach the finish line, they lunge forward with their shoulders and head, narrowly crossing the finish line.

Once the child recovers from their 100-m dash, the parent and child review the video segment of the child's performance. In many conventional approaches, the video will contain flaws, such as a blurriness to a foreground including the child and a background including stands and other athletes. This can be due to a real-time video processing pipeline of the parent's smartphone globally applying motion blur to the foreground and the background of the video segment to hide judder resulting from the parent's quick panning of the smartphone. Without the motion blur, the background of the video segment would include judder, or a stuttering artifact resulting from the quickly panned action shot. However, although noticeable judder is reduced with the motion blur, the foreground, which includes the parent's child, is also blurry. This quality of the video is an undesirable result for both the parent and child.

This document describes systems of and techniques for removing distortion from real-time video using a masked frame. The disclosed systems and techniques may address a blurry foreground in a video segment resulting from a global application of motion blur. The systems and techniques extract the foreground from the video segment, thereby separating the foreground from the background and enabling editing of the background separate from the foreground. The following discussion describes operating environments, techniques that may be employed in the operating environments, and example methods. Although systems and techniques directed at removing distortion from real-time video using a masked frame are described, the subject of the appended claims is not limited to the specific features or methods described. Rather, the specific features and methods are disclosed as example implementations, and reference is made to the operating environment by way of example only.

### Example Environment

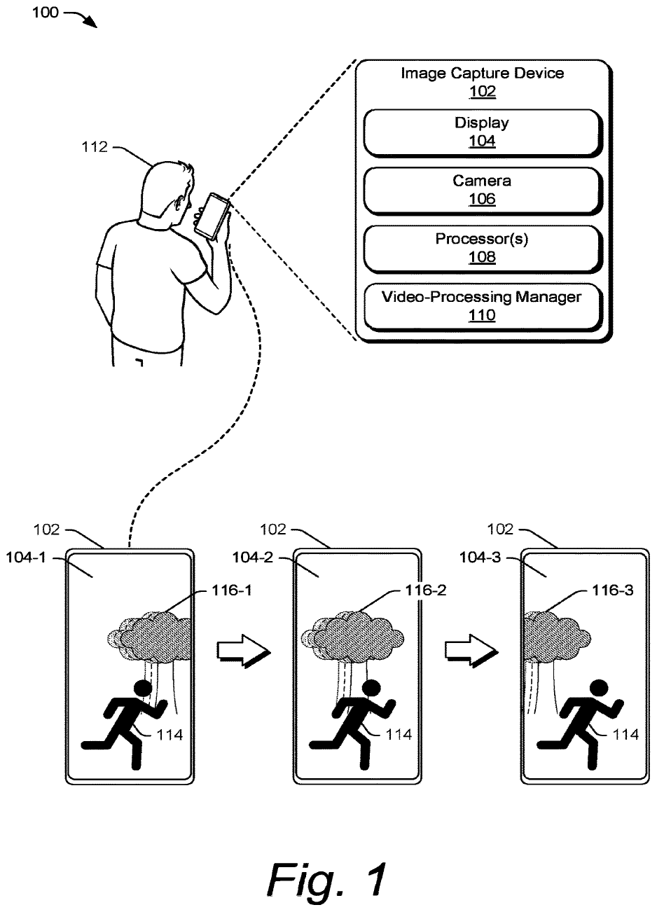

FIG. 1 illustrates an example environment 100 in which an image-capture device 102 may implement aspects of removing distortion from real-time video using a masked frame. The image-capture device 102 includes a display 104, a camera 106, one or more processors 108, and a video-processing manager 110 configured to extract a foreground of a video segment in real time. In one example, a user 112 wishes to take a video of an athlete 114 sprinting past a tree 116. The user 112 takes out the image-capture device 102, opens a camera application (not shown) installed on the image-capture device 102, selects a video mode (not shown), and taps a shutter button (not shown) to begin recording the athlete 114 sprinting past the tree 116.

In response to the user 112 tapping the shutter button, the video-processing manager 110 captures a video segment comprising a sequence of frames, which includes a prior frame and a current frame received immediately after the first frame. The video-processing manager 110 receives a subject mask for the current frame. The subject mask may be generated, for example, using a machine-learned (ML) model on the image-capture device 102. The video-processing manager 110 receives motion vectors for the current frame, which may be generated by an optical flow measurement tool on the image-capture device 102. The optical flow measurement tool may generate, for example, the motion vectors using the prior frame and the current frame. The video-processing manager 110 receives a predicted mask for the current frame. The predicted mask may be generated from the motion vectors and the prior frame. For example, the video-processing manager 110 may modify (e.g., translate, scale, rotate) a mask for the prior frame in accordance with the motion vectors for the current frame. The video-processing manager 110 generates a final mask for the current frame based on the subject mask, the motion vectors, and the predicted mask. The video-processing manager 110 then applies the final mask to the current frame to provide a masked frame, for which a foreground and a background are segmented from each other. The video-processing manager 110 edits the masked frame to remove distortion from the masked frame to generate an output frame. As an example, the distortion may be a judder in the background of the masked frame, and the edits applied by the video-processing manager 110 may be a motion blur. The video-processing manager 110 may apply the motion blur to the background of the masked frame to hide the judder. Next, the video-processing manager 110 outputs the output frame.

The video-processing manager 110 may repeat the method described herein for a second current frame in relation to which the current frame is a second prior frame. As an example, a sequence of frames includes a first frame, a second frame, a third frame, and a fourth frame. For a first iteration of the method, the first frame is the prior frame and the second frame is the current frame. The video-processing manager may implement one or more parts of the method to generate a final mask for the second frame. For a second iteration of the method, the second frame is the second prior frame and the third frame is the second current frame. Within the context of the second iteration, the second frame is the prior frame and the third frame is the current frame. For a third iteration of the method, the third frame is the second prior frame and the fourth frame is the second current frame. That is, within the context of the third iteration, the third frame is the prior frame and the fourth frame is the current frame. Although four frames were described in the present example, the sequence of frames can include any number of frames, and the video-processing manager may iterate through prior, current, second prior, and second current frames until a final mask is generated for each frame of the sequence of any number of frames.

After recording the video segment of the athlete 114 in a foreground sprinting past the tree 116 in a background, the user 112 reviews the video segment. As illustrated in FIG. 1, a display 104-1 illustrates a first frame of a sequence of three or more frames. The sprinting athlete 114 is centered in a foreground of the first frame. The tree 116-1 is on a right-hand side in a background of the first frame. As illustrated, the tree 116-1 includes a dark front face and two lighter faces to the left. The two lighter faces of the tree 116-1 represent a motion blur applied to the background of the first frame.

Further illustrated by a display 104-2 is a second frame of the sequence of three or more frames. Again, the athlete 114, centered in a foreground of the second frame, sprints past the tree 116-2 centered in a background of the second frame. The tree 116-2 includes the dark front face and two lighter faces to the left to represent a motion blur applied to the background of the second frame.

The display 104-3 further illustrates a third frame of the sequence of three or more frames. The athlete 114 remains centered in a foreground of the third frame. The athlete 114 continues to sprint past the tree 116-3 on a left-hand side of a background of the third frame. Again, the tree 116-3 includes the dark front face and two lighter, left-hand faces to represent a motion blur applied to the background of the third frame. The user 112 is satisfied with the video segment because the video-processing manager 110 extracted the foreground from the video segment in real time and applied motion blur to the background only to hide judder in the background. Although judder is described, the distortion can be any distortion. Similarly, although editing the background of a video segment is described, the video-processing manager 110 may implement any one of the disclosed systems and techniques to edit the foreground of a video segment.

### Example Implementations

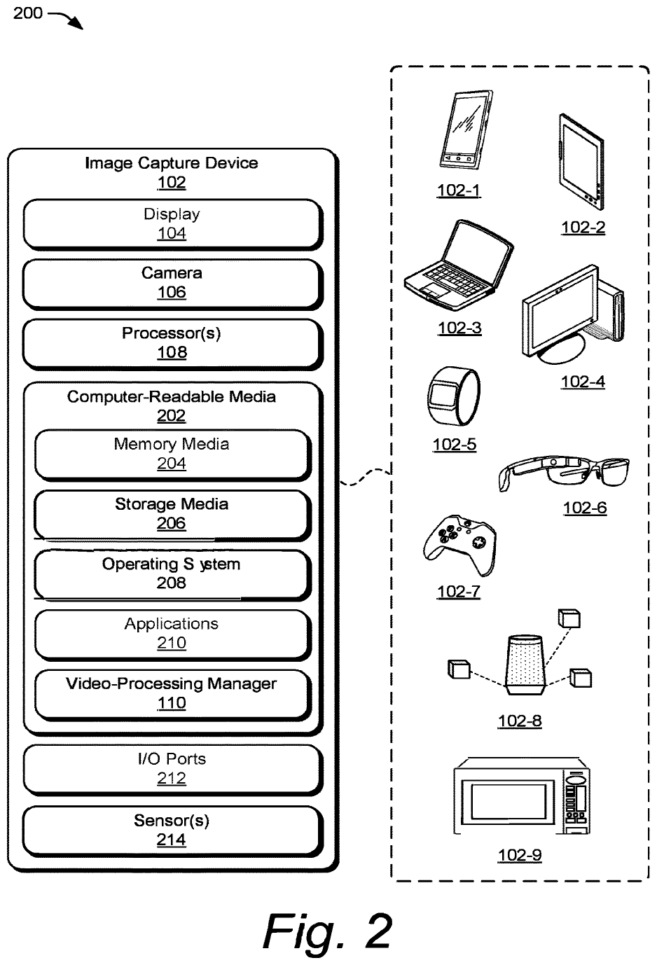

FIG. 2 illustrates an example implementation 200 of the image-capture device 102 from FIG. 1 in more detail. The image-capture device 102 is illustrated as a variety of example devices, including consumer electronic devices. As non-limiting examples, the image-capture device 102 can be a smartphone 102-1, a tablet 102-2, a laptop computer 102-3, a desktop computer 102-4, a smartwatch 102-5, a pair of smart glasses 102-6, a game controller 102-7, a speaker 102-8, or a microwave appliance 102-9. Although not shown, the image-capture device 102 may also be implemented as an audio recording device, a health monitoring device, a home automation system, a home security system, a gaming console, a personal media device, a personal assistant device, a drone, a home appliance, and the like. Note that the image-capture device 102 can be wearable, non-wearable but mobile, or relatively immobile (e.g., desktop computers, home appliances). Note also that the image-capture device 102 can be used with, or embedded within, many image-capture devices 102 or peripherals, such as in automotive vehicles or as an attachment to a personal computer. The image-capture device 102 may include additional components and interfaces omitted from FIG. 2 for the sake of clarity.

As illustrated in FIG. 2, the image-capture device 102 includes a display 104, a camera 106, and processors 108. The display 104 can be any one of a variety of displays, including a light-emitting diode (LED) display, an organic light-emitting diode (OLED) display, an in-plane switching (IPS) display, a twisted nematic (TN) display, and so forth. The display may be referred to as a “screen” so that content (e.g., images, videos) may be displayed “on-screen.” The camera 106 can include one or more image sensors, one or more lenses, one or more auto-focus motors, a flash, image stabilization components, and so forth. The camera 106 may be configured to capture video at various resolutions (e.g., 1080p, 2k, 4k) and framerates (e.g., 30 fps, 60 fps, 120 fps). The camera 106 may include an associated application, with which a user may interact to adjust capture settings (e.g., resolution, framerate) and review captured images and videos. The processors 108 may include one or more of an appropriate single-core or multi-core processor, such as a graphics processing unit (GPU) or a central processing unit (CPU).

The image-capture device 102 includes computer-readable media (CRM) 202, also illustrated in FIG. 2. The CRM 202 includes memory media 204 and storage media 206. The memory media 204 and storage media 206 may include one or more non-transitory storage devices, such as random-access memory (RAM), dynamic RAM (DRAM), a solid-state drive (SSD), a magnetic spinning hard drive disk (HDD), or any other type of storage media suitable for storing electronic instructions, each coupled with a data bus. The term “coupled” may refer to two or more elements that are in direct contact (e.g., physically, electrically, magnetically, optically) or to two or more elements that are not in direct contact with each other but still cooperate or interact with each other.

The CRM 202 further includes an operating system (OS) 208, applications 210, and a video-processing manager 110. The OS 208, applications 210, and video-processing manager 110 may be implemented as computer-readable instructions on the CRM 202, which can be executed by the processors 108 to provide some or all the functionalities described herein. For example, the processors 108 may perform specific computational tasks of the OS 208 directed at removing distortion from real-time video using a masked frame. The applications 210 may include power-management applications, camera applications, background service applications, communication applications (e.g., audio calling, video calling), and so forth.

In aspects, implementations of the video-processing manager 110 may include one or more integrated circuits (ICs), a system on a chip (SoC), a secure key store, hardware embedded with firmware stored on read-only memory (ROM), a printed circuit board (PCB) with various hardware components, or any combination thereof. As described herein, a system for removing distortion from real-time video using a masked frame may include one or more components of the image-capture device 102, as illustrated in FIGS. 1 and 2, configured to remove distortion from real-time video using a masked frame. In additional implementations, the system for removing distortion from real-time video using a masked frame may be implemented as the image-capture device 102.

Further illustrated in FIG. 2, the image-capture device 102 includes input/output (I/O) ports 212. The I/O ports 212 enable the image-capture device 102 to interact with other devices or users through peripheral devices, transmitting any combination of digital, analog, or radio frequency signals. The I/O ports 212 may include any combination of internal or external ports, such as universal serial bus (USB) ports, audio ports, video ports, dual inline memory module (DIMM) card slots, peripheral component interconnect express (PCIe) slots, and so forth. Various peripherals may be operatively coupled with the I/O ports 212, such as human input devices (HIDs), external CRM, speakers, displays, keyboards, mice, or other peripherals. Although not shown, the image-capture device 102 can also include a system bus, interconnect, or data transfer system that couples with the various components within the image-capture device 102. A system bus or interconnect can include any one or combination of different bus structures, such as a memory bus, a peripheral bus, a USB, a local bus, or a processor bus that utilizes one of a variety of bus architectures.

Furthermore, the image-capture device 102 includes one or more sensors 214, as illustrated in FIG. 2. The sensors 214 may be disposed anywhere on or in the image-capture device 102. Additionally, or alternatively, the sensors 214 may be disposed on or in a peripheral device connected (e.g., wirelessly, wired) to the image-capture device 102. The sensors 214 may include any of a variety of sensing components, such as an audio sensor (e.g., a microphone), a touch input sensor (e.g., a touchscreen), an image sensor (e.g., a phase detect autofocus sensor, part of a camera or camera system), an ambient light sensor (e.g., a photodetector), an acceleration sensor (e.g., an accelerometer), a proximity sensor (e.g., a laser detect autofocus sensor), or a pressure sensor (e.g., a barometer). The sensing components can be disposed within a housing of the image-capture device 102. In implementations, the image-capture device can include more than one of any one or more of the sensing components.

### Example Methods

In the following section, example methods are described that the video-processing manager 110 from FIGS. 1 and 2 may perform to implement aspects of removing distortion from real-time video using a masked frame. The methods are shown as sets of blocks that specify operations or acts performed by the video-processing manager 110, processors 108, sensors 214, or other components of the image-capture device not mentioned. The methods are not limited to the order or combinations of the sets of blocks shown for performing the operations by the respective blocks. Furthermore, any one or more of the operations may be repeated, combined, reorganized, or linked to provide additional or alternate methods. In the following discussion, reference may be made, for example only, to the example implementations and entities detailed in FIGS. 1 and 2.

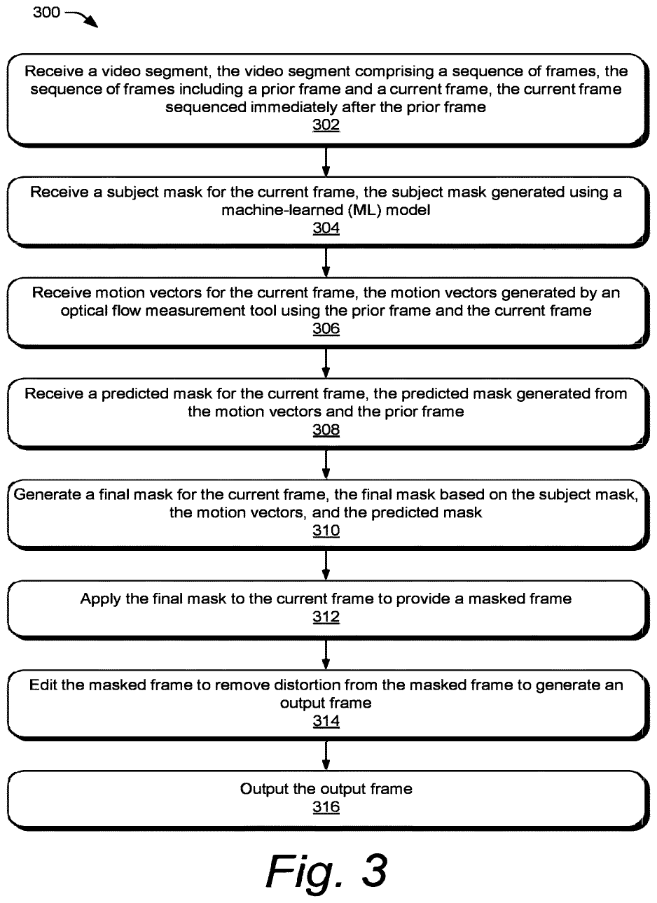

FIG. 3 illustrates an example method 300 for extracting a foreground from a video segment in accordance with one or more aspects. At 302, a video-processing manager (e.g., video-processing manager 110) receives a video segment. The video-processing manager may capture the video segment using an image-capture device (e.g., image-capture device 102), components thereof (e.g., camera 106, sensors 214), or a combination thereof. For example, the video-processing manager may utilize a camera of an image-capture device to capture the video segment. The video segment is comprised of a sequence of frames including a prior frame and a current frame received immediately after the prior frame. As an example, a video segment may include ten frames, the first of which is the prior frame. Accordingly, the second frame coming immediately after the first frame is the current frame.

At 304, the video-processing manager receives a subject mask for the current frame. The subject mask may be generated using a machine-learned (ML) model. The ML model may be trained using marked subjects, such as humans, vehicles, pets, or other subjects of interest that may reside in a foreground of a video segment. Additionally, the ML model may reside on an image-capture device, for example, as computer-readable instructions stored on a CRM (e.g., CRM 202) of the image-capture device. At 306, the video-processing manager receives motion vectors for the current frame. The motion vectors may be generated by an optical flow measurement tool (e.g., an inverse compositional implementation of Lucas-Kanade method) using the prior frame and the current frame. The optical flow measurement tool may be stored, for example, as computer-readable instructions on a CRM of an image-capture device. The motion vectors generated by the optical flow measurement tool describe a change in position of a pixel or group of pixels from the prior frame to the current frame. The motion vectors may be stored, for example, as a heatmap or another appropriate encoding on a CRM (e.g., CRM 202) of an image-capture device. At 308, the video-processing manager receives a predicted mask for the current frame. The predicted mask is generated from the motion vectors and the prior frame. For example, a mask for the prior frame may be aligned (e.g., rotated, translated, scaled) to the current frame using the motion vectors.

At 310, the video-processing manager generates a final mask for the current frame. The final mask is based on the subject mask, the motion vectors, and the predicted mask. For example, the video-processing manager may generate the final mask by taking a conjunction of the subject mask and the predicted mask. Although not shown, the video-processing manager may apply a sharpening operation to the final mask before proceeding to 312. The sharpening operation may be based on a luma (e.g., grayscale) version of the current frame, a bilateral grid, and the final mask. The sharpening operation may sharpen the edge of the final mask to avoid a dull or rough final mask.

At 312, the video-processing manager applies the final mask to the current frame to provide a masked frame. The final mask segments a foreground of the masked frame from a background of the masked frame. At 314, the video-processing manager edits the masked frame to remove distortion from the masked frame to generate an output frame. As an example, the distortion may be judder in the background of the masked frame. Judder can result from a three-two pulldown, a video shot at a low framerate (e.g., 24 fps, 30 fps), a quickly panned video shot, or a combination thereof. By segmenting the foreground from the background of the masked frame using the final mask, the video-processing manager enables separate editing of the foreground and the background of the masked frame. Accordingly, the video-processing manager may apply motion blur solely to the background of the masked frame to hide judder. At 316, the video-processing manager outputs the output frame. In this example, the output frame includes motion blur applied to the background and no edits applied to the foreground, thereby hiding judder in the background and maintaining a sharp foreground. In implementations, the video-processing manager may apply edits to the foreground, the background, both the foreground and the background, or neither the foreground nor the background. Further, the edits may include any one or more of a variety of edits, including, but not limited to, cuts, color adjustments, highlight adjustments, filter applications, Gaussian blurs, or motion blurs.

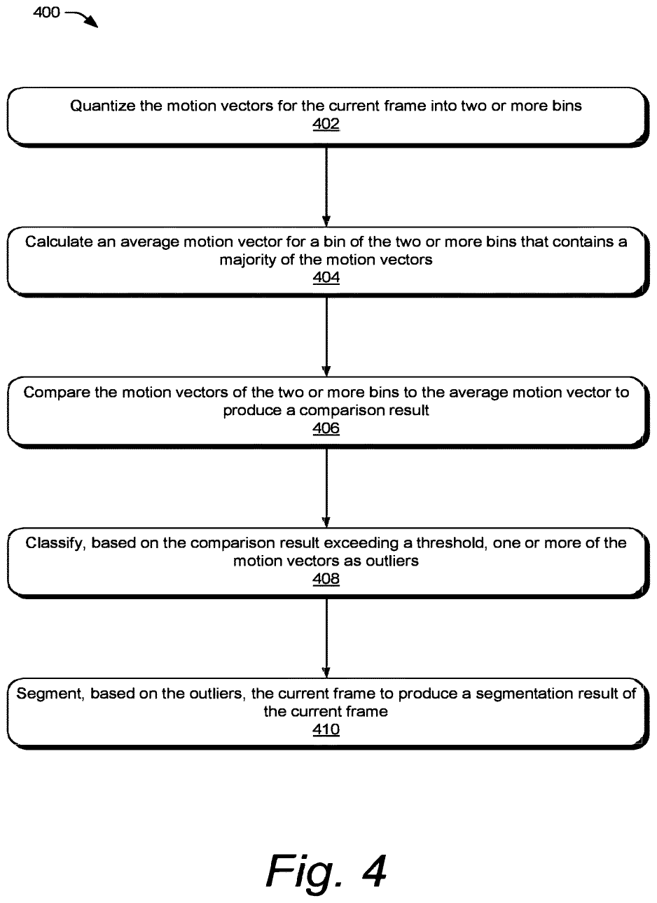

FIG. 4 illustrates an example method 400 for segmenting a current frame of a sequence of frames to produce a segmentation result. Any one of the blocks illustrated in the example method 400 may be repeated, combined, reorganized, or linked with sets of blocks in the example method 400 or the example method 300. For example, the example method 400 may utilize the motion vectors received at 306 of the example method 300.

At 402, a video-processing manager quantizes motion vectors for the current frame into two or more bins. The two or more bins may include one or more motion vectors per bin. The bins group similar motion vectors together, which may be used in step 404.

At 404, the video-processing manager calculates an average motion vector for a bin of the two or more bins that contains a majority of the motion vectors. As an example, refer to the example environment 100 of FIG. 1. Because the user 112 panned the image-capture device 102 to keep the athlete 114 centered in the foreground of the video segment, the motion vectors may be grouped into two bins. A first bin contains the motion vectors for the background and a second bin contains the motion vectors for the foreground. Further, because the athlete 114 takes up less space in each frame of the video segment, the background motion vector bin may be the bin that contains the majority of the motion vectors. Accordingly, the video-processing manager may calculate the average motion vector for the background bin.

At 406, the video-processing manager compares the motion vectors of the two or more bins to the average motion vector to produce a comparison result. In the present example, the average motion vector for the background bin is larger than any of the motion vectors in the foreground bin. This disparity is due to the user 112 panning the image-capture device 102 to keep the athlete 114 centered in the foreground. Relative to the image-capture device 102, the athlete 114 does not move. Said differently, the foreground motion vectors are close to zero. Unlike the athlete 114 in the foreground, the tree 116 in the background moves relative to the image-capture device 102. Said differently, the background motion vectors are greater than zero. In the present example, the comparison result may indicate that the foreground motion vectors are less than the average motion vector of the background motion vectors.

At 408, the video-processing manager classifies, based on the comparison result exceeding a threshold, one or more of the motion vectors as outliers. The threshold may be a whole number, a fraction, a percentage, a difference relative to another value (e.g., the average motion vector), or another quantifier that a motion vector may be compared against. In the present example, the video-processing manager may classify the foreground motion vectors as outliers on the basis that they are less than the average motion vector by a difference (e.g., ten percent, 15 percent). As additional examples, the video-processing manager may classify a motion vector as an outlier if it is greater than the average motion vector by a difference (e.g., ten percent, 25 percent). As further examples, the video-processing manager may classify a motion vector as an outlier if it is close to zero, close to infinity, close to another whole number, or close to another standalone value.

At 410, the video-processing manager segments, based on the outliers, the current frame to produce a segmentation result of the current frame. Continuing with the present example, the segmentation result may include two segments, one for the foreground and one for the background. The video-processing manager may, based on the foreground segment and the background segment, edit the background separately from the foreground, the foreground separately from the background, or a combination of both. Further, when combined with the example method 300, the video-processing manager may generate the final mask by combining the segmentation result with the predicted mask.

In some aspects, the video-processing manager may utilize distance information from additional sensors (e.g., sensors 214) of the image-capture device. For example, the video-processing manager may utilize distance information from a proximity sensor (e.g., sonar, RADAR, LIDAR) to more quickly or accurately identify a foreground or a background of a prior or current frame. The distance information may include a distance measurement (e.g., 6 m, 15 m) for the foreground and a distance measurement (e.g., 25 m, 31 m) for the background. The video-processing manager may segment, based on the distance information from the proximity sensor, the foreground of the current frame from the background of the current frame. As another example, the video-processing manager may utilize a second camera having a different point of view than a first camera to identify a foreground or a background of a current frame. The background of the current frame may appear similar from the point of view of the first camera and the point of view of the second camera. The foreground of the current frame may appear different from the point of view of the first camera and the point of view of the second camera. The video-processing manager may segment the foreground from the background of the current frame based on the differences in the foreground, or similarities in the background, from the different points of view.

Throughout this discussion, examples are provided of a video-processing manager editing a background of a frame of a sequence of frames of a video segment. However, the systems and techniques described herein are not limited to editing the background of a frame. In aspects, the systems and techniques may also be implemented by a video-processing manager to edit a foreground of a frame. Additionally, or alternatively, the systems and techniques described herein may be implemented by a video-processing manager in a long-exposure photo application. For example, suppose a user wants to take a photo of a subject in low light. To do so, the user frames a shot of the subject using an image-capture device having the video-processing manager configured for removing distortion from real-time video using a masked frame. The video-processing manager may capture multiple frames of the subject in low light using a long exposure time. The long exposure time provides enough time for sufficient light to be captured by an image sensor of the image-capture device for each frame. If the user has shaky hands when the multiple frames are captured at the long exposure time, the subject can be blurry. However, the video-processing manager may implement the techniques and systems described herein to segment a background from a foreground of the multiple frames. The video-processing manager may use motion vectors, for example, to perform the segmentation. The video-processing manager may also use the motion vectors to stabilize (e.g., by aligning a foreground mask with the motion vectors to a current frame) the foreground of the long-exposure frames in real time, resulting in a clear foreground. The multiple frames may be combined (e.g., overlaid), for example, into a single output photo having a clear foreground.

### Additional Examples

In the following section, additional examples are provided.
Example 1: A method comprising: receiving a video segment, the video segment comprising a sequence of frames, the sequence of frames including a prior frame and a current frame, the current frame sequenced immediately after the prior frame; receiving a subject mask for the current frame, the subject mask generated using a machine-learned (ML) model; receiving motion vectors for the current frame, the motion vectors generated by an optical flow measurement tool using the prior frame and the current frame; receiving a predicted mask for the current frame, the predicted mask generated from the motion vectors and the prior frame; generating a final mask for the current frame, the final mask based on the subject mask, the motion vectors, and the predicted mask; applying the final mask to the current frame to provide a masked frame; editing the masked frame to remove distortion from the masked frame to generate an output frame; and outputting the output frame.
Example 2: The method of example 1, wherein: the video segment is captured by, and received from, a camera of an image-capture device; the ML model is on the image-capture device; and the optical flow measurement tool is on the image-capture device.
Example 3: The method of example 1, further comprising: quantizing the motion vectors for the current frame into two or more bins; calculating an average motion vector for a bin of the two or more bins that contains a majority of the motion vectors; comparing the motion vectors of the two or more bins to the average motion vector to produce a comparison result; classifying, based on the comparison result exceeding a threshold, one or more of the motion vectors as outliers; and segmenting, based on the outliers, the current frame to produce a segmentation result of the current frame.
Example 4: The method of example 3, wherein the final mask is generated by combining the segmentation result of the current frame with the predicted mask.
Example 5: The method of example 1, wherein the predicted mask is generated by aligning, using the motion vectors, a final mask of the prior frame to the current frame.
Example 6: The method of example 1, further comprising: performing, prior to applying the final mask to the current frame, a sharpening process on the final mask.
Example 7: The method of example 6, wherein: the sharpening process is performed by an edge sharpening tool; and the edge sharpening tool is on an image-capture device from which the video segment is received.
Example 8: The method of example 1, wherein the prior and current frames include a background, a foreground in front of the background, and a subject of interest in the foreground.
Example 9: The method of example 8, wherein editing the masked frame to generate the output frame further comprises: editing the background of the masked frame.
Example 10: The method of example 8, wherein editing the masked frame to generate the output frame further comprises: editing the foreground of the masked frame.
Example 11: The method of example 8, wherein editing the masked frame to generate the output frame further comprises: editing the foreground and the background of the masked frame.
Example 12: The method of example 8, further comprising: receiving distance information for the current frame, the distance information captured by a sensor of an image-capture device; and segmenting, based on the distance information, the foreground of the current frame from the background of the current frame.
Example 13: The method of example 8, further comprising: receiving point-of-view information for the current frame, the point-of-view information captured by a different image-capture device; and segmenting, based on the point-of-view information, the foreground of the current frame from the background of the current frame.
Example 14: An image-capture device comprising: at least one camera; one or more sensors; one or more processors; and memory storing instructions that, when executed by the one or more processors, cause the one or more processors to implement a video processing manager to provide video processing utilizing the at least one camera and the one or more processors by performing the method of any one of the preceding claims.
Example 15: A computer readable medium comprising instructions that, when executed by one or more processors, cause the one or more processors to carry out the method of any one of the claims 1 to 13.

### Conclusion

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying Drawings and terms discussed herein may be indicative of one or more items or terms, and thus reference may be made interchangeably to single or plural forms of the items and terms in this written description.

Although implementations of systems and techniques for, as well as apparatuses enabling, removing distortion from real-time video using a masked frame have been described in language specific to certain features and/or methods, the subject of the appended claims is not necessarily limited to the specific features or methods described. Rather, the specific features and methods are disclosed as example implementations of removing distortion from real-time video using a masked frame.

1. A method comprising:
receiving a video segment, the video segment comprising a sequence of frames, the sequence of frames including a prior frame and a current frame, the current frame sequenced immediately after the prior frame;
receiving a subject mask for the current frame, the subject mask generated using a machine-learned (ML) model;
receiving motion vectors for the current frame, the motion vectors generated by an optical flow measurement tool using the prior frame and the current frame;
receiving a predicted mask for the current frame, the predicted mask generated from the motion vectors and the prior frame;
generating a final mask for the current frame, the final mask based on the subject mask, the motion vectors, and the predicted mask;
applying the final mask to the current frame to provide a masked frame;
editing the masked frame to remove distortion from the masked frame to generate an output frame; and
outputting the output frame.

2. The method of claim 1, wherein:
the video segment is captured by, and received from, a camera of an image-capture device;
the ML model is stored on a computer-readable medium (CRM) of the image-capture device; and
the optical flow measurement tool is stored on the CRM of the image-capture device.

3. The method of claim 1, further comprising:
quantizing the motion vectors for the current frame into two or more bins;
calculating an average motion vector for a bin of the two or more bins that contains a majority of the motion vectors;
comparing the motion vectors of the two or more bins to the average motion vector to produce a comparison result;
classifying, based on the comparison result exceeding a threshold, one or more of the motion vectors as outliers; and
segmenting, based on the outliers, the current frame to produce a segmentation result of the current frame.

4. The method of claim 3, wherein the final mask is generated by combining the segmentation result of the current frame with the predicted mask.

5. The method of claim 1, wherein the predicted mask is generated by aligning, using the motion vectors, a final mask of the prior frame to the current frame.

6. The method of claim 1, further comprising:
performing, prior to applying the final mask to the current frame, a sharpening process on the final mask.

7. The method of claim 6, wherein:
the sharpening process is performed by an edge-sharpening tool; and
the edge-sharpening tool is on an image-capture device from which the video segment is received.

8. The method of claim 1, wherein the prior and current frames include a background, a foreground in front of the background, and a subject of interest in the foreground.

9. The method of claim 8, wherein editing the masked frame to generate the output frame further comprises:
editing the background of the masked frame.

10. The method of claim 8, wherein editing the masked frame to generate the output frame further comprises:
editing the foreground of the masked frame.

11. The method of claim 8, wherein editing the masked frame to generate the output frame further comprises:
editing the foreground and the background of the masked frame.

12. The method of claim 8, further comprising:
receiving distance information for the current frame, the distance information captured by a sensor of an image-capture device; and
segmenting, based on the distance information, the foreground of the current frame from the background of the current frame.

13. The method of claim 8, further comprising:
receiving point-of-view information for the current frame, the point-of-view information captured by a different image-capture device; and
segmenting, based on the point-of-view information, the foreground of the current frame from the background of the current frame.

14. An image-capture device comprising:
at least one camera;
one or more sensors;
one or more processors; and
memory storing instructions that, when executed by the one or more processors, cause the one or more processors to implement a video-processing manager to provide video processing utilizing the at least one camera, the one or more sensors, and the one or more processors by performing operations comprising:
receiving a video segment, the video segment comprising a sequence of frames, the sequence of frames including a prior frame and a current frame, the current frame sequenced immediately after the prior frame;
receiving a subject mask for the current frame, the subject mask generated using a machine-learned (ML) model;
receiving motion vectors for the current frame, the motion vectors generated by an optical flow measurement tool using the prior frame and the current frame;
receiving a predicted mask for the current frame, the predicted mask generated from the motion vectors and the prior frame;
generating a final mask for the current frame, the final mask based on the subject mask, the motion vectors, and the predicted mask;
applying the final mask to the current frame to provide a masked frame;
editing the masked frame to remove distortion from the masked frame to generate an output frame; and
outputting the output frame.

15. A computer-readable medium (CRM) comprising instructions that, when executed by one or more processors, cause the one or more processors to carry out operations comprising:
receiving a video segment, the video segment comprising a sequence of frames, the sequence of frames including a prior frame and a current frame, the current frame sequenced immediately after the prior frame;
receiving a subject mask for the current frame, the subject mask generated using a machine-learned (ML) model;
receiving motion vectors for the current frame, the motion vectors generated by an optical flow measurement tool using the prior frame and the current frame;
receiving a predicted mask for the current frame, the predicted mask generated from the motion vectors and the prior frame;
generating a final mask for the current frame, the final mask based on the subject mask, the motion vectors, and the predicted mask;
applying the final mask to the current frame to provide a masked frame;
editing the masked frame to remove distortion from the masked frame to generate an output frame; and
outputting the output frame.
